(19) United States
(12) Patent Application Publication
(10) Pub. No.: US 2002/0114895 A1
(43) Pub. Date: Aug. 22, 2002

(54) Green lumber dip machine

(75) Inventors: Harless B. Kuntz, Del Rio, TX (US); Lowell B. McClung, Summersville, WV (US)

Correspondence Address: Susan E. Shaw McBee, Heller Ehrman White & McAuliffe LLP, Suite 300, 1666 K Street, N.W., Washington, DC, 20006, US

(73) Assignee: Metalcraft Mining Equipment Rebuilders, Inc.

(21) Appl. No.: 09/788,438

(22) Filed: Feb. 21, 2001

(51) Int. Cl. B05D 1/18

(52) U.S. Cl. 427/430.1

(57) ABSTRACT

A lumber dipping machine comprising an immersion tank, a hoist mechanism, an apparatus for feeding packs of green lumber along a chain conveyor onto a pack shove mechanism where the pack is clamped against movement and lowered into a tank of anti-fungal solution. After the lumber is saturated, the electrically driven hoist mechanism lifts it out and slides the treated lumber down an outfeed conveyor and away from the worksite, making way for another pack of lumber that needs to be treated.

### BACKGROUND OF THE INVENTION

1. Field of the Invention

The present invention relates to methods and apparatus for use in conveying and handling materials such freshly cut logs or other materials and more particularly, to methods and apparatus for handling logs and/or board infeed lumber of multiple sizes.

2. Description of Related Art

U.S. Pat. No. 5,351,833 to Quick shows a chain conveyor drive in an overhead diagram in FIG. 1. The conveyor of the Quick invention uses only three chains spaced apart, giving the entire mechanism fairly limited pulling power and limited ability to accept various pack sizes.

U.S. Pat. No. 4,453,491 to Hite et al. shows a lumber dipping apparatus with an infeed conveyor that is not integrally built on to the station. The Hite invention is equipped with an outfeed conveyor. This is often included in lumber dip station apparatus.

U.S. Pat. No. 4,407,229 to Sanborn is a hoist for dipping pack lumber into an anti-fungal bath. The hoist in the Sanborn patent comes equipped with hydraulic lifters and a stand-up hoist frame with inclined struts.

U.S. Pat. No. 3,203,559 to Macy is a lumber sorting device that uses a box-like frame and longitudinal rail decks to form a mechanism for sorting, grading and piling planar-sized pieces of lumber.

The above mentioned patent references demonstrate some of the limitations of apparatus on the market. It would be preferable to minimize exposure to the elements by supplying the apparatus with a roof. The drippings create an irritating atmosphere for workers as well as a wasted resource. The materials to be processed by a lumber dip station are extremely heavy. Apparatus presently known in the industry does not come equipped with a strong enough set of material handling machines to reliably transfer such ponderous loads.

### SUMMARY OF THE INVENTION

An object of the present invention is to provide an apparatus which will take selected packs of lumber and transmit them to a conveyor.

Another object of the present invention is to provide an apparatus with the capability to handle large loads of wood using supporting arms which come into contact with supporting means on the transfer rack so that packs of articles can be safely transferred between the handling implements the rack.

Another object of the present invention is to provide an apparatus which will automate and make more efficient the process of dipping large packs of green lumber into an anti-fungal solution.

Another object of the present invention is to provide an apparatus with capability to handle large loads of wood using supporting arms which come into contact with supporting means on the transfer rack so that packs of articles can be safely transferred between the handling implements and the rack.

In accordance with these and other objects, the present invention relates to a green lumber dip machine comprising: an infeed conveyor, a pack shove mechanism, a dip platform and an outfeed conveyor.

The present invention further relates to an apparatus for treating a material comprising a transfer mechanism, a lifting and hoisting apparatus, a treatment zone, a way to hold the materials in place while in the treatment zone. The materials may comprise logs or board lumber packs. The treatment itself may comprise a liquid anti-fungal, sapstain solution. The treatment zone or area may comprise a concrete, below-ground, open topped tank. The transfer mechanism may comprise a chain-driven, horizontal conveyor. The hoist may comprise a hydraulic lift on a vertical stanchion mounted permanently in the concrete of the bottom of the open topped tank.

Yet further, the present invention is directed to methods for treating a material comprising: transferring the material from a first location to a second location using a first conveyor; positioning the material from said first conveyor to a preselected orientation on a treatment platform; moving at least a portion of the material from the treatment platform to a treatment area so as to provide treatment to the material; repeating the moving until the treatment is complete; and transferring the material from the treatment platform to a second location using a second conveyor.

Additional objects, features and advantages of the invention will be set forth in the description which follows, and in part, will be obvious from the description, or may be learned by practice of the invention. The objects, features and advantages of the invention may be realized and obtained by means of the instrumentalities and combination particularly pointed out in the appended claims.

### BRIEF DESCRIPTION OF THE DRAWINGS

The accompanying drawings, which are incorporated in and constitute a part of the specification, illustrate a presently preferred embodiment of the invention, and. together with the general description given above and the detailed description of the preferred embodiment given below, serve to explain the principles of the invention.

FIG. 1. is a side view of the dip tank showing the hoist mechanism and dip tank in relation to ground level.

FIG. 2. is a top view of the system apparatus showing infeed and outfeed conveyors with the tank and hoist in the middle.

FIG. 3, is a platform profile of the entire machine revealing the motor and sheave wheels mechanisms as well as the hoist frame in relation to the conveyors.

### DETAILED DESCRIPTION OF A PREFERRED EMBODIMENT

The present invention relates to a green lumber dip machine comprising: an infeed conveyor 5, a pack shove mechanism 7, a dip platform 2 and an outfeed conveyor 6. The system is driven by a dual electrical 9 and hydraulic 4 arrangement with a gear reducer combination 8. Infeed 5 and outfeed 6 conveyors run on four horizontal chains 11, 12, 13, 14. The machine dips the lumber by means of hydraulics 4 mounted on an upright frame 1 while holding the wood down in the liquid 15. The dip platform 2 places lumber up and down with regard to the dip tank 3. The dip platform 2 then raises the wood such as board lumber or a bundle of logs, and shoves the pack onto the outfeed conveyor 6.

The present invention is an apparatus with the capability to handle large loads of wood (not shown) using supporting arms that work in concert with supporting means 1 on the transfer rack 7 so that packs of lumber can be safely transferred from the handling implements to the dip platform. Upon arrival from a sawmill or the field, the wood or boards which are generally in multiple lengths and sizes, a conveyor is employed to transfer the materials to a “pack shove mechanism” 7 which moves the materials into a suitable orientation for immersion into the dip tank 3. After the wood materials have been treated in the solution, for eventual shipping or storage, the wood is then moved down an outfeed conveyor 6.

The green lumber dip machine generally comprises four main parts: an infeed conveyor 5, a pack shove mechanism 7, a dip platform 2 and an outfeed conveyor 6. A main shaft (not shown) is preferably electrically driven by a motor 9 and gear reducer 8 combination. Infeed 5 and outfeed 6 conveyors are driven by four horizontal chains 11, 12, 13, 14. The machine dips the lumber by means of an upright frame 1 which lowers it up and down into the solution 15. The dip platform then raises it and shoves it onto the outfeed conveyor 6.

When a normal sized package of lumber arrives at the platform, the hoist puts the entire load into a tank 3. This way the boards all get soaked and the solution penetrates into the interior of the wood bundle. But one problem is that the new boards need to be treated with a slightly toxic anti-mildew solution so that the lumber doesn't degrade during storage or shipment. It would be very desirable for the solution not to splash all over and contaminate the area. This way the workers aren't exposed to an irritating and possibly toxic dose of liquid fungicide. The heavy lumber packages can be hoisted in and out of the tank with a simple, rugged hoist mechanism which works in concert with the conveyor to handle potentially large volumes of newly cut boards as they arrive from the sawmill by rail or truck. The boards to be selected will depend on the length and quality of the lumber.

If you spray these wood preservatives on the product out in the open, there is some wastage and the products themselves don't receive an adequate dose to protect them. Another problem is that the entire atmosphere is tainted with the spray and the result is that the workers in the vicinity have irritating and possibly dangerous substances land on them.

There is an associated problem with the lumber dipping operation which the instant invention seeks to solve and that is the dripping of solution as the lumber is hoisted in and out of the tank. With the instant invention and conveyor, the entire unwieldy package can slide smoothly into the anti-fungal bath and not splash the liquid around the adjacent work spaces. This represents an important advantage.

The dip tank itself is preferably built of poured concrete. An in-ground stainless steel tank is usually undesirable since metals are subject to corrosion. However, any tank material can be employed that is capable of handling/containing the material sought to be used as a treatment. Another preferably concrete portion of this lumber dip facility is the slanted runway underneath the outfeed conveyor. Concrete is a suitable material which can withstand the solution's corrosiveness. A concrete runway under the outfeed conveyor will be more resistant to damage should a lumber pack fall off and strike it. When the dip tank is stainless steel, it may be susceptible to sustain dents and gash marks from the lumber. Therefore a feature of the instant invention is its ruggedness and low maintenance characteristic.

As mentioned above, a pack of freshly cut lumber is a bulky commodity to handle or jostle about in a busy yard with workers moving here and there along with all the various activities including vehicles loading, unloading, pack transfers, storage operations and a multitude of things happening. The operation is further complicated when the unloading of the pack takes place above floor level.

Packs of lumber generally include the same type of members in each group. These generally are pieces with like attributes such as length, thickness, width, species, quality. The conveyor of the instant invention is advantageously spaced on 55 inch centers in order to accommodate packs from, for example, 6 to 16 feet in length. These packs are in some embodiments from up to 42 inches wide and up to 36 inches tall.

This entire selection process, with all its attendant care, may operate somewhat differently when soft woods are being treated. Examples of soft woods include pine, fir and cedar. The pores of soft wood have more cavities. The solution penetrates more quickly with lighter woods of greater porosity. And here the key word is volume; this means that soft woods will soak a greater volume of the treatment medium.

The infeed conveyor 5 is capable of handling successive loads. There are numerous possible industrial applications in which a stacked load must be conveyed for further handling. Other materials that could be used with the present apparatus and methods include handling and x-raying of cargo at a terminal or the handling and sterilizing of contaminated earth at a cleanup site. In the inventive system the conveyor generally comprises four chain tracks spaced apart to accept different pack lengths. The lumber carrying conveyor travels over the pack shove mechanism which shifts in increments. A pack of lumber moving along the conveyor will trip a switch depending upon progress. This is a safety feature to prevent packs of lumber from wrecking on the conveyors.

After the infeed 5 conveyor has performed its task, the pack shove mechanism 7 takes over. The pack shove mechanism functions to move a green lumber pack from the infeed 5 conveyor to the dip platform 2. The boards are shoved from a single point horizontally and will come to rest in an orderly fashion on the dip platform The mechanism achieves this by shuttling forward and backward on a one plane drive with hydraulics 4. The pack shove 7 and conveyors 5 6 use a 100 hp electric motor 9. All individual electrical features can be solenoid controlled (not shown) if desired for a particular use. The hydraulic pumps (not shown) are three stage. Each stage of the pump operates a separate feature: hoist, pack shove or clamp. Hydraulic power available to an operator of this mechanism is considerable. The platform 2 can lift 9,000 pounds of lumber. When one factors in the weight of the platform itself, lifting capacity is in excess of 12,000 pounds.

The third important component of the inventive system is the dip platform 2. The dip platform lowers a fresh cut pack of green lumber into the solution 15 that reduces sapstain. At this point the actual heart of the work gets accomplished. For a person with no experience in this industry, the dip platform 2 is one part of this entire operation that he or she might most easily understand. The dip platform is generally a vertically movable carriage. An operator pushes a button and the hoisting platform runs through its cycle with an immersion period. If the immersion period requires adjustment, for instance, the mill methods are such that various pack sizes receive longer immersions in the treatment agent, then the system software allows the supervisor to customize certain individual operations. Otherwise the lift will automatically cycle through its preselected set of procedures. At the beginning of the cycle the carriage starts in an up position. The worker pushes the cycle-on button. This powers up the system and turns the motor on. The hydraulics 10 go into operation and with the package of lumber secured on the dip platform 2, the cycle of lowering and raising goes into effect.

In prior systems, the operator frequently has to check the status of the pack. Then, using a formula of weight and density to time, tries to manually calculate how long each pack needs to stay under for maximum product treatment. This is inexact. It would be better for the operator to perform a less complex procedure. The object of the inventive system is to automate as much as possible, the treatment of packaged lumber for eventual shipment.

With the instant invention an operator with only a moderate amount of training and supervision can update the computer with new cycle times. As the pack timber is lowered into the tank of liquid preservative, the hydraulic clamp on the top of the assembly will prevent the buoyant wood from floating off the platform and force timber to absorb the preservative throughout all the grain. An operator, as he or she gets used to the system, will discover that predictions for the lumber products to be submerged are accurate enough that a moisture check is not necessary. The dunking schedule might then move to full auto with the operator allowing the computer to independently stage and perform the immersion/absorption program with each new pack passing along through the station. As a result a more efficient immersion process is achieved as more packs cycle through the system.

With regard to the pump (not shown), an operator can run each function individually. Manufacturers of the inventive system can customize the individual machine for each user according to individual needs. With its versatility, one section of the pump can operate all features, if need arises.

After all others in chronology or sequence, the outfeed conveyor 6 gets the transfer of the treated packs. The outfeed conveyor's purpose is to take a lumber pack a given distance so the pack can be unloaded safely from the machine. As additional packs of lumber end up on the outfeed conveyor 6, any packs which already received a dose of the liquid 15 move down at the end of the conveyor 6. Here a forklift operator can take them or they can be allowed to roll down a grocery store style slide to await further handling. An interesting design feature of the outfeed and infeed 5 conveyors is that all parts of both machines match to assure ease in maintenance and parts inventory. This is suited to the overall improved form of system construction: economical to manufacture and reliable in everyday operation. The outfeed conveyor lets the lumber load operations continue even when there are no trucks available to remove them from the site except, if there is no storage space left on-site. At the point the computer or the operator intervenes, loading of the untreated packs into the immersion tank 3 is a pre-requisite for the operation to run smoothly. Another advantage of the outfeed station is that it allows the excess antifungal solution to drip off while waiting to be conveyed away. The drip area underneath consists of a slanted/tilted floor (not shown) that routes the excess fluid to a sump station. At the sump station, a user can pump the leftover fluid back into the main holding tank 3.

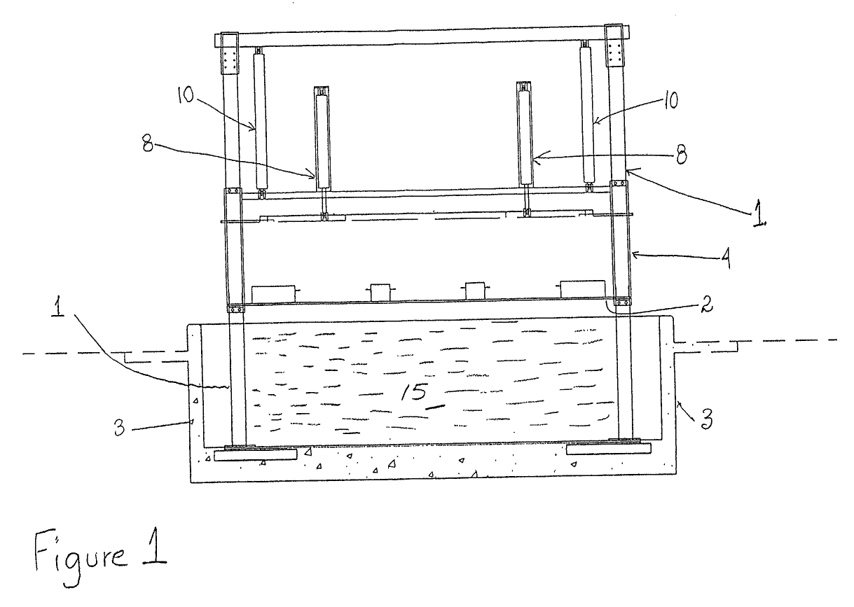

Referring to FIG. 1., Side View of Dip Tank, the hoist frame (1.) rises vertically over the top of the dip platform (2.). The hoist frame is an upstanding steel structure. It, the hoist frame (1.) stands up from inside the dip tank (3.) anchored by a clamp. Hoist carriage (4.) slides up and down on the frame (1). Typically a load of lumber get s to the dip platform, supported by the hoist carriage, by coming off the infeed conveyor (5.) from which it is shoved. Then the hoist carriage lowers itself with the lumber on it into the anti-fungal solution in the tank. When the wood has been thoroughly saturated, the carriage goes up again. At this point the lumber is shoved on to the outfeed conveyor (6.). Then the lumber moves off to storage or transport at the end of the outfeed. Hydraulic hoist jack (10.) provides vertical motive power for hoist platform (2.).

Referring to FIG. 2., Top View of the Green Lumber Dip Lumber Apparatus, the diagram shows the pack shove mechanism (7.) which moves the lumber packs from the infeed conveyor (5.) to the dip platform. Conveyor (5.) consists of four chain tracks evenly spaced on 55 inch centers to accept different pack widths. The pack shove is horizontal in the direction of movement of the infeed conveyor (5.). The chains for the drive run down and around the toothed sheave wheels (8.) through the 5 hp drive motor (9.) under the conveyor in an endless loop. Electrical connections (not shown) incorporate drive motor (9.). Motor operates the infeed conveyor. A push button on the controller (not shown) causes the apparatus to start and stop. Computer (not shown) permits the operator to select the size of the pack. The infeed conveyor (5.) is also timed to receive information from the electric eye sensor (not shown). The computer controls the hoist frame (1.) with the weight and bulk of the desired number of boards to be submerged in the dip tank. (3.).

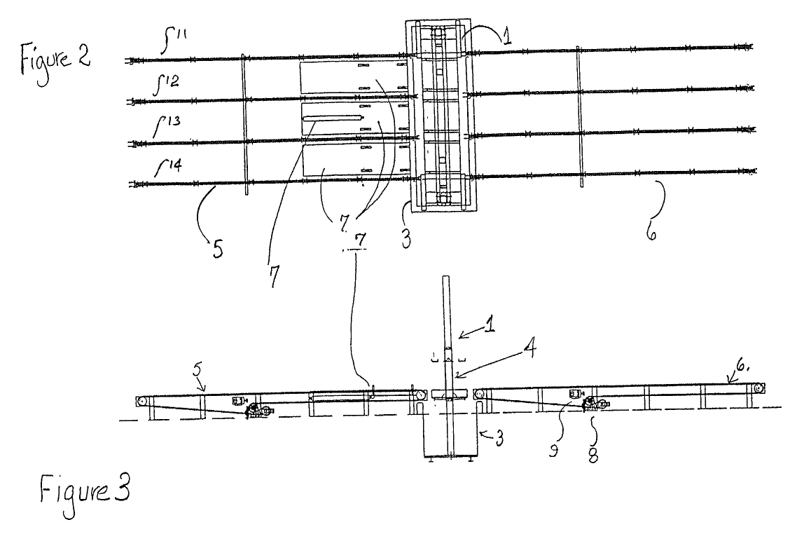

Referring now to FIG. 3., Green Lumber Dip Tank Platform Profile, the hoist carriage (3.) lowers a fresh pack of lumber in to the dip tank full of a solution that reduces sapstain. After a suitable length of time in the solution 15, the platform is raised. Clamp jack (8.) secures the pack on to the platform so as to counteract the natural buoyancy of the lumber as it is submerged into the solution. Underneath the space between the pack shove 7 mechanism and the hoist carriage 2 is a drip area collector basin (not shown). The leftover solution from the pack lumber collects in this drip area consisting of a tilted floor that lets the runoff go to a sump station( not shown). Then this solution is re-used in the dip tank. Above outfeed conveyor (6.), is a long roof (not shown) to protect treated lumber from the elements. If rain or snow were to land on a treated pack, some of the solution in the wood grains might be dissipated by the outside moisture. Hence the protective roof.

Additional advantages, features and modifications will readily occur to those skilled in the art. Therefore, the invention in its broader aspects is not limited to the specific details, and representative devices, shown and described herein. Accordingly, various modifications may be made without departing from the spirit or scope of the general inventive concept as defined bye the appended claims and their equivalents.

As used herein and in the following claims, articles such as “the”, “a” and “an” can connote the singular or plural.

All documents referred to herein are specifically incorporated herein by reference in their entireties.

What is claimed is:

1. A lumber handling apparatus comprising:
a. an infeed conveyor for transferring said lumber from a first location to a dip platform,
b. a pack shove mechanism for orienting said lumber into a configuration suitable for treatment,
c. a dip platform which is adjacent to said pack shove mechanism;
d. a dip tank which is adjacent to said dip platform;
e. a hoist mechanism which is capable of moving said lumber in and out of said dip tank; and
f. an outfeed conveyor, which is adjacent to said dip tank and transfers said lumber from said dip platform to a second location.

2. An apparatus as defined in claim 1 wherein the apparatus is electrically driven by a motor and gear reducer combination.

3. An apparatus as defined in claim 2 wherein the infeed and outfeed conveyor are driven by four horizontal chains.

4. An apparatus as defined in claim 3 wherein the chain driven infeed and outfeed conveyors are configured to be as one unit with the dip platform and dip tank mounted directly opposite one another on either side of the dip tank.

5. An apparatus as defined in claim 4 wherein the drive mechanism of the infeed and outfeed conveyors comprises four equally spaced chains aligned horizontally from the dip tank and pack shove mechanism.

6. An apparatus as defined in claim 5 wherein the pack shove mechanism is operated by hydraulics.

7. An apparatus as defined in claim 6 wherein said hoist mechanism is capable of lowering and raising said lumber in and out of the dip tank

8. An apparatus as defined in claim 7 wherein the dip platform uses a clamp which secures the lumber onto the platform as the lumber is submerged in the dip tank.

9. An apparatus as defined in claim 8, wherein the clamp operates with hydraulic pressure.

10. An apparatus as defined in claim 9. wherein the pack shove mechanism and the clamp are each supplied with pressure from a multi-chambered pump which is configured to run the hoist, pack shove and clamp on a separate pump stage.

11. An apparatus for treating a material comprising:
a transfer mechanism for transferring said material from a first location to a treatment zone, a lifting and hoisting apparatus for moving said material in and out of said treatment zone, a holder to keep said material stationary while said material is in said treatment zone.

12. An apparatus for treating a material as in claim 11. wherein said material comprises logs or board lumber packs.

13. An apparatus for treating a material as in claim 12 wherein said transfer apparatus comprises a horizontal conveyor with four chains conveyor powered by an electric motor on an endless drive with gear reduction.

14. An apparatus for treating a material as in claim 13. wherein said treatment zone includes a liquid anti-fungal, sapstain solution.

15. An apparatus for treating a material as in claim 14. wherein said treatment zone comprises a concrete, below-ground, open topped tank.

16. An apparatus for treating a material as in claim 15. wherein said lift mechanism comprises a hydraulic powered hoist mounted on a vertical stanchion wherein said stanchion is anchored permanently in concrete of the bottom of the open topped tank.

17. A method for treating a material comprising:
transferring said material from a first location to a second location using a first conveyor;
positioning said material from said first conveyor to a preselected orientation on a treatment platform;
moving at least a portion of said material from said treatment platform to a treatment area so as to provide treatment to said material;
repeating said moving until said treatment is complete; and
transferring said material from said treatment platform to a second location using a second conveyor.

18. A method according to claim 17, wherein said moving is accomplished using a hydraulic hoist and said treatment area is a tank positioned adjacent to said treatment platform, and said second conveyor is different from said first conveyor.
